(19) United States
(12) Patent Application Publication
(10) Pub. No.: US 2026/0249116 A1
(43) Pub. Date: Aug. 27, 2026

(54) FIRE-RESISTING MASK-TYPE VEHICLE FIRE-EXTINGUISHING DEVICE

(71) Applicant: Ebiologic Technology Co., Ltd., New Taipei City (TW)

(72) Inventor: Erik CHEN, New Taipei City (TW)

(21) Appl. No.: 19/061,124

(22) Filed: Feb. 24, 2025

(51) Int. Cl. A62C 3/07; A62C 8/06; A62C 35/13; A62C 37/11

(52) U.S. Cl. CPC A62C 3/07; A62C 8/06; A62C 35/13; A62C 37/11

(57) ABSTRACT

A fire-resisting mask-type vehicle fire-extinguishing device includes a base body, a sprinkler portion and a fire-resisting masking cloth. When a vehicle is burning, an infrared heat sensor and a smoke detector on an exterior side of the base body will detect temperature anomaly and smoke, and then the fire-resisting masking cloth will be inflated by a carbon dioxide storage tank, so that the fire-resisting masking cloth can be expanded to shield the vehicle below, and the vehicle can be isolated from outside. In a meantime, a fire-resisting agent storage tank will spray the fire-resisting agent onto an inner side of the fire-resisting masking cloth by the sprinkler portion below the base body, thereby achieving the object of putting out the fire from the burning of the vehicle.

### BACKGROUND OF THE INVENTION

### (a) Field of the Invention

The present invention relates to a fire-resisting mask-type vehicle fire-extinguishing device, and more particularly to a device that can shield a vehicle and put out fire when the fire breaks out to the vehicle.

### (b) Description of the Prior Art

As the rising of environmental awareness worldwide, many countries now have planned to gradually replace the conventional fuel vehicle with the electric vehicle powered by electricity, thereby reducing the pollution to environment from the vehicle. In addition, the electric vehicle will not even discharge carbon dioxide in driving, as the conventional fuel vehicle will. Therefore, the electric vehicle has already been a future trend. However, currently the electric vehicle depends primarily upon a battery beneath the chassis to provide power and the electricity that is needed for the entire vehicle. As the battery contains easily combustible substances, there are quite a lot of cases that the fire breaks out to the electric vehicle due to improper charging, too high the temperature, and damage to the battery. Although there are sprinkler systems on an indoor parking lot to prevent the fire, as the battery is located at the bottom of the vehicle, the fire-extinguishing agent will be shielded by the vehicle body when sprinkling, and hence the effect of fire extinguishing is limited. Moreover, a lot of toxic gases will be generated when the battery is burning, and there is no way to stop the spreading of toxic gases only by sprinkling.

### SUMMARY OF THE INVENTION

The primary object of the present invention is to provide a fire-resisting mask-type vehicle fire-extinguishing device, formed by a base body, a sprinkler portion and a fire-resisting masking cloth. When a vehicle is burning, an infrared heat sensor and a smoke detector will detect temperature anomaly and smoke, and then the fire-resisting masking cloth will be inflated by a carbon dioxide storage tank, so that the fire-resisting masking cloth can be expanded to shield the vehicle below, and the vehicle can be isolated from outside. In a meantime, a fire-resisting agent storage tank will spray the fire-resisting agent onto an inner side of the fire-resisting masking cloth by the sprinkler portion below the base body, thereby achieving the object of putting out the fire from the burning of the vehicle.

To achieve the abovementioned object, the base body is provided with a data processing module and a communication module, and the data processing module is connected to the communication module.

To achieve the abovementioned object, an interior of the base body is provided additionally with a power supply module, and the power supply module is connected electrically to the data processing module of the base body.

To achieve the abovementioned object, the sprinkler portion is disposed below an open accommodation space.

To achieve the abovementioned object, the fire-resisting masking cloth is rectangular, and a lower side thereof is hollow.

To achieve the abovementioned object, the fire-resisting masking cloth is provided with an intake gas column, upper gas columns, side gas columns and lower gas columns; whereas, the intake gas column, the upper gas columns, the side gas columns, and the lower gas columns are connected with one another.

To achieve the abovementioned object, the fire-resisting masking cloth is made of aluminum oxide.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional perspective view of the present invention.

FIG. 2 shows a structural block diagram of the present invention.

FIG. 3 shows a three-dimensional exploded view of the present invention.

FIG. 4 shows a partial schematic view of the present invention.

FIG. 5 shows a schematic view of a preferred embodiment of the present invention.

### DETAILED DESCRIPTION OF THE PREFERRED EMBODIMENTS

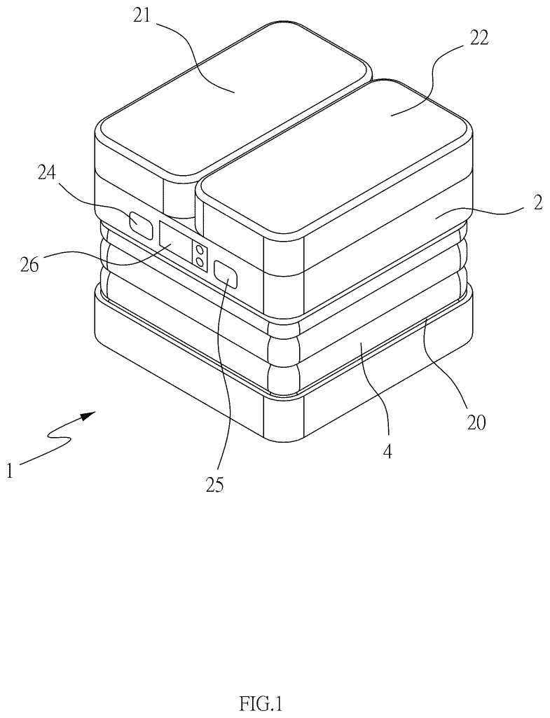

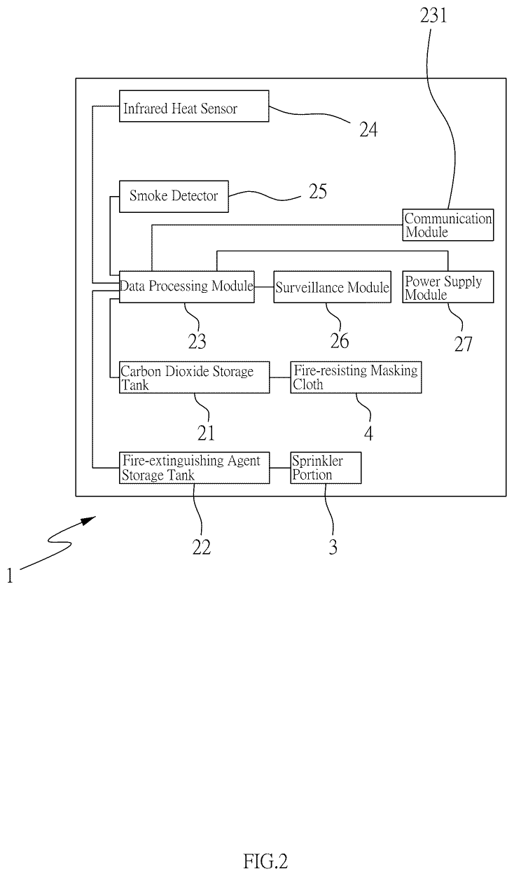

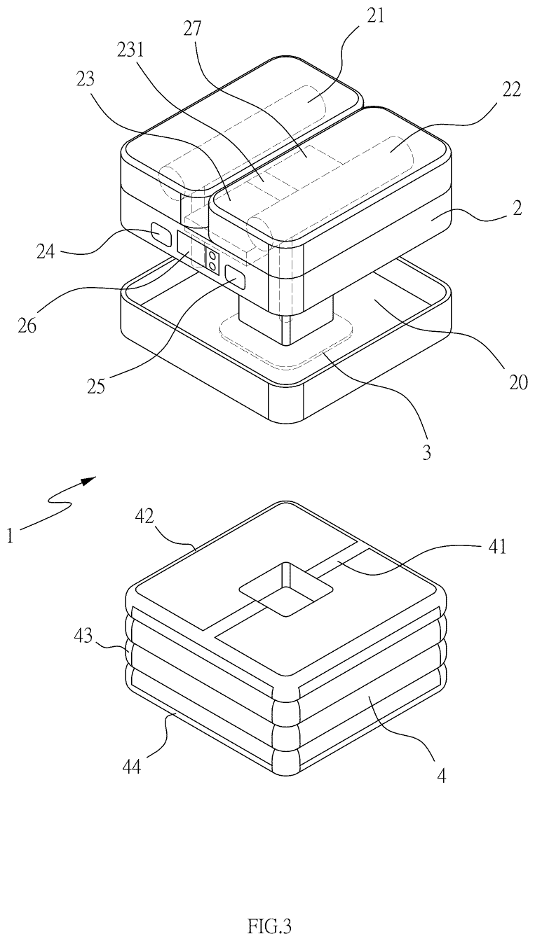

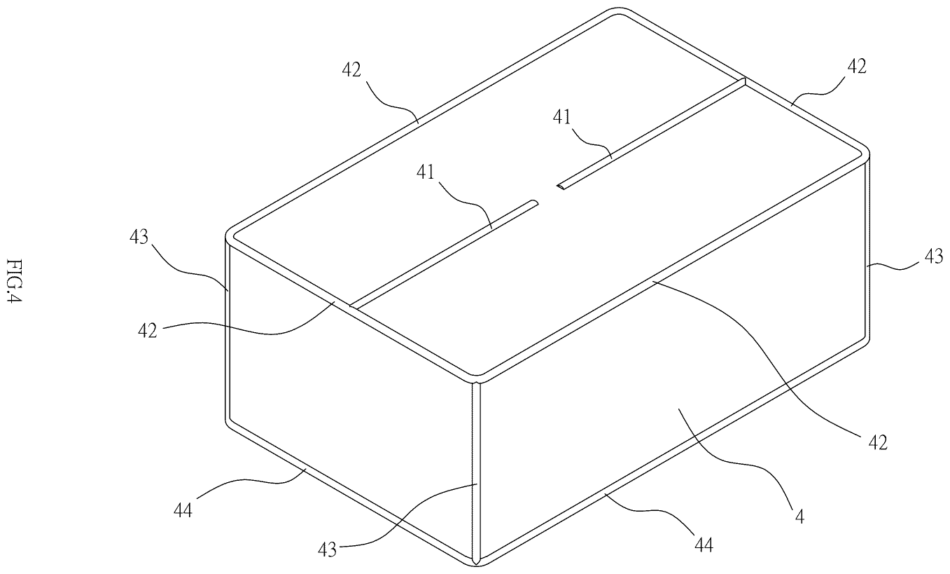

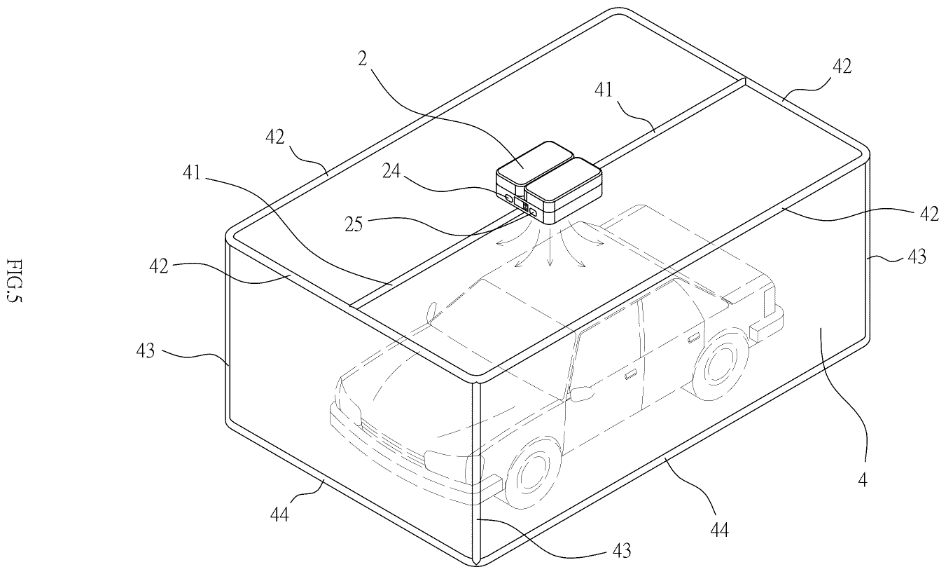

Referring to FIG. 1, FIG. 2, FIG. 3, FIG. 4, and FIG. 5, it shows a three-dimensional perspective view, a structural block diagram, a three-dimensional exploded view, a partial schematic view, and a schematic view of a preferred embodiment, of the present invention. As shown in the drawings, the fire-resisting mask-type vehicle fire-extinguishing device 1 comprises primarily a base body 2, a lower side of which is provided with an open accommodation space 20, with that an interior of the open accommodation space 20 is provided with a carbon dioxide storage tank 21, a fire-extinguishing agent storage tank 22, and a data processing module 23, whereas an exterior side of the open accommodation space 20 is provided with an infrared heat sensor 24, a smoke detector 25, and a surveillance module 26; a sprinkler portion 3, which is disposed below the base body 2, and is interconnected with the fire-extinguishing agent storage tank 22 of the base body 2; and a fire-resisting masking cloth 4, which is folded and disposed inside the open accommodation space 20 of the base body 2, with that an outer surface of the fire-resisting masking cloth 4 is provided at least with an intake gas column 41, plural upper gas columns 42, plural side gas columns 43, and plural lower gas columns 44, wherein the intake gas column 41 is interconnected with the carbon dioxide storage tank 21 of the base body 2.

The data processing module 23 is connected additionally to a communication module 231.

An interior of the base body 2 is provided additionally with a power supply module 27, and the power supply module 27 is connected electrically to the data processing module 23 of the base body 2.

The sprinkler portion 3 is disposed below the open accommodation space 20.

The fire-resisting masking cloth 4 is rectangular, and a lower side thereof is hollow.

The intake gas column 41, the upper gas columns 42, the side gas columns 43, and the lower gas columns 45 are connected with one another.

The fire-resisting masking cloth 4 is made of aluminum oxide.

In using the fire-resisting mask-type vehicle fire-extinguishing device 1 of the present invention, the fire-resisting mask-type vehicle fire-extinguishing device 1 is primarily installed on the ceiling above a parking space. When a vehicle parked in the parking space is burning, as high temperature and smoke from burning will diffuse upward, the infrared heat sensor 24 disposed on the exterior side of the base body 2 will detect that the temperature rises up abnormally, and the smoke detector 25 will detect the smoke. Next, the detected signals will be transmitted to the data processing module 23, and the data processing module 23 will then activate the carbon dioxide storage tank 21 to release carbon dioxide and inflate the fire-resisting masking cloth 4, expanding the fire-resisting masking cloth 4 to shield the entire vehicle. At the same time when the fire-resisting masking cloth 4 is expanded, the data processing module 23 will even activate the fire-extinguishing agent storage tank 22 to spray out the fire-extinguishing agent in the fire-extinguishing agent storage tank 22 through the sprinkler portion 3 below the base body 2, thereby achieving the object of putting out the fire from the burning of the vehicle.

Accordingly, when the carbon dioxide storage tank 21 inflates the fire-resisting masking cloth 4, carbon dioxide first enters into the intake gas column 41, and then into the upper gas columns 42, side gas columns 43, and lower gas columns 44 sequentially. Finally, when the fire-resisting masking cloth 4 is full of carbon dioxide, the fire-resisting masking cloth 4 can be expanded completely and shield the vehicle, so that the vehicle can be isolated from outside. Therefore, in addition to that high temperature and smoke from the burning of the vehicle can be stopped from diffusing outward, the fire can be put out by the fire-extinguishing agent that is sprayed out from the fire-extinguishing agent storage tank 22.

Furthermore, the sprinkler portion 3 is disposed below the open accommodation space 20, meaning that the sprinkler portion 3 has to be disposed at the lowest side of the base body 2. Thus, only when the fire-resisting masking cloth 4 is expanded completely and shields the vehicle that the fire-extinguishing agent that is sprayed out from the fire-extinguishing agent tank 22 can be filled into the entire fire-resisting masking cloth 4, thereby contacting the vehicle successfully to put out the fire.

Moreover, the surveillance module 26 on the exterior side of the base body 2 can be used to monitor the conditions of carbon dioxide storage tank 21, fire-extinguishing agent storage tank 22 and power supply module 27. In addition, a user can even carry out related settings through the surveillance module 26; for example, the activation time of carbon dioxide storage tank 21 and fire-extinguishing agent storage tank 22, or how much temperature and smoke that the infrared heat sensor 24 and the smoke detector 25 detect to further activate the carbon dioxide storage tank 21 and the fire-extinguishing agent storage tank 22.

On the other hand, when the data processing module 23 activates the carbon dioxide storage tank 21 and the fire-extinguishing agent storage tank 22, the data processing module 23 will even send out the fire information through the communication module 231, thereby notifying related personnel to reach the site for processing as soon as possible.

Accordingly, in comparison to the conventional fire sprinkling system existing in all kinds of shortcomings and being unable to put out the fire effectively, primarily by the special design of base body 2, sprinkler portion 3 and fire-resisting masking cloth 4 of the fire-resisting mask-type vehicle fire-extinguishing device 1 of the present invention, when the vehicle is burning, the vehicle can be isolated from outside and high temperature and smoke can be avoided from diffusing outward by the shielding of fire-resisting masking cloth 4, and the fire can be put out by the fire-extinguishing agent that is sprayed out from the fire-extinguishing agent storage tank 22, so that the fire from the burning of vehicle can be put out quickly and effectively.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A fire-resisting mask-type vehicle fire-extinguishing device, comprising
a base body, a lower side of which is provided with an open accommodation space, with that an interior of the open accommodation space is provided with a carbon dioxide storage tank, a fire-extinguishing agent storage tank, and a data processing module, whereas an exterior of the open accommodation space is provided with an infrared heat sensor, a smoke detector, and a surveillance module;
a sprinkler portion, which is disposed below the base body and is interconnected with the fire-extinguishing agent storage tank; and
a fire-resisting masking cloth, which is folded and disposed in the open accommodation space of the base body, and an outer surface of the fire-resisting masking cloth is provided with an intake gas column, plural upper gas columns, plural side gas columns, and plural lower gas columns, wherein the intake gas column is interconnected with the carbon dioxide storage tank of the base body.

2. The fire-resisting mask-type vehicle fire-extinguishing device according to claim 1, wherein the data processing module is connected additionally to a communication module.

3. The fire-resisting mask-type vehicle fire-extinguishing device according to claim 1, wherein an interior of the base body is provided additionally with a power supply module, and the power supply module is connected electrically to the data processing module of the base body.

4. The fire-resisting mask-type vehicle fire-extinguishing device according to claim 1, wherein the sprinkler portion is disposed below the open accommodation space.

5. The fire-resisting mask-type vehicle fire-extinguishing device according to claim 1, wherein the fire-resisting masking cloth is rectangular, and a lower side thereof is hollow.

6. The fire-resisting mask-type vehicle fire-extinguishing device according to claim 1, wherein the intake gas column, upper gas columns, side gas columns, and lower gas columns are connected with one another.

7. The fire-resisting mask-type vehicle fire-extinguishing device according to claim 1, wherein the fire-extinguishing masking cloth is made of aluminum oxide.
